(19) United States
(12) Patent Application Publication
(10) Pub. No.: US 2025/0373626 A1
(43) Pub. Date: Dec. 4, 2025

(54) VISCAD: VISUAL-GUIDED CAMPAIGN AUTO-DISCOVERY

(71) Applicant: Palo Alto Networks, Inc., Santa Clara, CA (US)

(72) Inventors: Zeyu You, Santa Clara, CA (US); Wei Wang, Milpitas, CA (US); Jingwei Fan, Chapel Hill, NC (US); Wenfu Feng, Santa Clara, CA (US)

(21) Appl. No.: 18/680,876

(22) Filed: May 31, 2024

(51) Int. Cl. H04L 9/40; G06V 20/00; G06V 30/19; G06V 30/30

(52) U.S. Cl. CPC H04L 63/1416; G06V 20/95; G06V 30/19107; G06V 30/19147; G06V 30/19173; G06V 30/30

(57) ABSTRACT

The present application discloses a method, system, and computer system for classifying samples. The method includes (a) grouping a plurality of images associated with a plurality of samples to obtain a set of image groups, wherein the plurality of images are grouped based at least in part on visual similarities, (b) determining one or more patterns from URLs for samples associated with images comprised in a particular image group, and (c) generating a signature for each of the determined one or more patterns form the URLs.

### BACKGROUND OF THE INVENTION

In the digital landscape, the proliferation of malware poses a significant threat to the integrity and security of network systems. Malicious actors continuously devise sophisticated techniques to evade detection by traditional security measures, necessitating the development of innovative approaches to combat evolving threats.

Conventional methods of detecting malware often rely on signature-based detection or heuristic analysis, which may struggle to keep pace with the rapid evolution of malicious software. As a result, there is a growing demand for advanced detection mechanisms capable of discerning subtle patterns indicative of malicious intent within vast datasets of network traffic or file samples.

One promising avenue for enhancing malware detection lies in the realm of pattern recognition and machine learning. By leveraging the power of artificial intelligence, particularly techniques such as deep learning and neural networks, it becomes possible to identify complex patterns and relationships within data that may elude human perception or conventional detection methods.

### BRIEF DESCRIPTION OF THE DRAWINGS

Various embodiments of the invention are disclosed in the following detailed description and the accompanying drawings.

FIG. 1 is a block diagram of an environment in which a malicious domain is detected or suspected according to various embodiments.

FIG. 2 is a block diagram of a system to classifying a set of samples according to various embodiments.

FIG. 3 is an illustration of a system for determining patterns among a set of samples according to various embodiments.

FIG. 4 is a block diagram of a system for training or using a classifier to classify images based on patterns derived from a set of samples based on image grouping according to various embodiments.

FIG. 5 is an example of hashing an image according to various embodiments.

FIG. 6 is a set of screenshots grouped based on image encoding according to various embodiments.

FIG. 7A is an example of a clustering of a set of samples using a URLNet-based model according to various embodiments,

FIG. 7B is an example of clustering a set of samples using a tree-based model according to various embodiments.

FIG. 7C is an example of URLs for which the system determines a set of patterns according to various embodiments.

FIGS. 8A-8C are a set of brand spoofing attacks detected by a visual-guided campaign auto-discovery (VisCAD) service or technique according to various embodiments.

FIG. 9 is a flow diagram of a method for determining patterns in URLs for samples according to various embodiments.

FIG. 10 is a flow diagram of a method for determining a set of image groups for a set of samples according to various embodiments.

FIG. 11 is a flow diagram of a method for determining a set of image groups for a set of samples according to various embodiments.

FIG. 12 is a flow diagram of a method for refining a set of image groups according to various embodiments.

FIG. 13 is a flow diagram of a method for matching a set of samples with a set of sample classifications according to various embodiments.

FIG. 14 is a flow diagram of a method for grouping a set of samples according to various embodiments.

FIG. 15 is a flow diagram of a method for training a model according to various embodiments.

FIG. 16 is a flow diagram of a method for detecting malicious traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments address the challenges posed by the rapid evolution of malicious exploits by grouping samples based on similarities. The samples are collected by a security service, such as by firewalls that collect samples during the mediation of traffic across a network. The system groups samples based on their intrinsic similarities, effectively creating clusters of related samples that can be used to derive patterns that can be used to classify the samples (e.g., using a machine learning classifier, a rule-based classifier, etc.). Rather than analyzing each sample independently, the system identifies common traits and patterns shared among samples within each group, thereby facilitating the detection of underlying malicious activities that may manifest in various forms across multiple instances.

Various embodiments leverage the power of image-based grouping techniques, wherein samples are represented as visual images. For example, the system captures images associated with the samples, such as by capturing a screenshot of a page hosted at a particular domain, etc. The use of image-based grouping techniques enables the system to efficiently process the numerous samples collected by a security service (e.g., by firewalls, next generation firewalls, etc.) to group samples for use in determining patterns across the samples that may be indicative of a particular sample classification (e.g., a malicious sample, a benign sample, etc.). In some embodiments, the system refines the image grouping to obtain a refined image grouping. The system can use the image grouping or the refined image grouping to perform clustering with respect to samples within each group. Examples of clustering include clustering URLs for the samples based on a set of heuristics, clustering URLs for the sample based on a URL-net based analysis (e.g., using a convolutional neural network (CNN) to detect clusters among the samples in a group), clustering the samples based on pattern extraction in the URL or HTML for the samples, or clustering based on a URL-pattern mining pipeline. The clustering the samples based on pattern extraction in the URL or HTML can be based on a prefix tree analysis, a generalized suffix tree analysis, a wild-card analysis, and/or a random-string detector.

Various embodiments provide a method, system, and computer system for classifying samples. The method includes (a) grouping a plurality of images associated with a plurality of samples to obtain a set of image groups, wherein the plurality of images are grouped based at least in part on visual similarities, (b) determining one or more patterns from URLs for samples associated with images comprised in a particular image group, and (c) generating a signature for each of the determined one or more patterns form the URLs.

Phishing attacks persistently emerge within our network data (e.g., network traffic data collected by firewalls, next generation firewalls, or other network nodes), constantly evolve, and pose challenges for machine learning (ML) models. The continual emergence of new exploits renders classifiers based on ML models used to classify samples (e.g., network traffic samples, etc.), thereby rendering such classifiers ineffective in adapting to these emergent exploit tactics. Oftentimes, retraining the existing classifiers (e.g., classifiers based on ML or deep learning (DL) models) or building a new classifier (e.g., training a new ML/DL model) results in counterproductive responses to emergent exploits (e.g., phishing campaigns) due to limited training examples and long ML/DL lifecycles. Therefore, building a system that automatically recognizes interconnected phishing campaigns would benefit in many ways.

Emerging or existing phishing campaigns that related art ML/DL models failed to properly classify (e.g., classifier detection misses or false negatives (FN), or only partial detection) were identified based on change requests to a security service associated with phishing detection misses. Analysis of the set of change requests resulted in observation that many detection misses by an ML/DL model-based classifier but share something in common. For example, the samples improperly classified or corresponding to detection misses had the same website appearance or same patterns in their corresponding URL and/or HTML. The system can identify phishing campaigns (e.g., emergent exploits or exploits that were not properly classified by related art classifier) by finding the common characteristics and hence improve the detections. Various embodiments implement an automated discovery of campaigns because of the frequency with which exploits are released, the numerous exploit tactics, and/or to address the difficulty in related art systems detection of exploits.

Various embodiment implements a visual-guided campaign auto-discovery (VisCAD) service or technique, which can be used in connection with a ML/DL platform for classifying samples and detecting exploits. The ML/DL platform VisCAD detects phishing and also benign campaigns based at least in part on (1) image hashing and/or encoding on images for samples (e.g., website screenshots), and (2) pattern extraction from grouped URL/HTML. The VisCAD service or technique can help increase the phishing detection efficacy (on both detection coverage increase and false positive reduction) and benign categorization accuracy. The VisCAD service or technique can also help provide contextual/visual explainability on the discovered campaigns to the customers.

The system can retrieve data (e.g., samples) from the production system for a network security service, and apply the VisCAD technique. In response to collecting the samples, the system employs image grouping techniques (based on images for the samples) to organize images based on their visual similarities. In some embodiments, the system implements an image hashing and/or an image encoding to process the images for a similarity detection/comparison. An example of a hashing technique includes Perceptual Image Hashing. An example of an image encoding technique includes processing the images using a ResNet-50 (e.g., a convolutional neural network) to encode images for similarity matching. Various other hashing and/or encoding techniques may be implemented. After grouping the samples based on the images (e.g., the image hashes and/or encoded images), the system collates the URLs that correspond to the identified image groups. According to various embodiments, the system applies a clustering and/or wildcard matching to find patterns from the URLs (e.g., the various groupings of URLs). The verified patterns are then used as signatures to cover undetected URLs for increasing detection coverage or to reduce false positives (FPs). Additionally, or alternatively, the system obtains HTMLs for the samples and determines patterns from the HTMLs for samples within the various image groupings. The system can use various techniques such as semantic parsing and Trie mining to identify text, link, and/or resource patterns from the HTMLs. These patterns can be used to improve benign categorization accuracy. The VisCAD technique or service can use these methodologies together to maximally extend detection efficiency and categorization accuracy.

In some embodiments, the VisCAD service was used to process samples captured from production for a security service (e.g., a next generation firewall). For example, the system implemented the VisCAD service to process consecutive days of screenshots stored. On average, the system stored approximately two hundred thousand samples per day, which corresponds to about two hundred thousand images (e.g., screenshots) captured daily. By processing these samples, the VisCAD service generates approximately 250-300 image groups (e.g., sample groups) per day. The sizes of 90% image groups are generally in between [100,500). After grouping the samples based on image groupings, the VisCAD service discovered about 100 URL patterns and more than 100,000 HTML patterns after filtering. Some of these discovered URL patterns in the were actually from a phishing email-attack campaign that was generated by the same phishing tool. Some HTML patterns are benign campaigns that can help increase the benign categorization.

According to various embodiments, the techniques described herein (e.g., the VisCAD service) has several benefits in providing sample classification (e.g., for network security services) over the related art. Examples of such benefits include:
Self-adaptivity: because the phishing page generated by a phishing kit is evolving quickly, automatic discovery of phishing campaigns can adapt to the change quickly and improve the detection coverage.
Speedup ML processes: by automatically discovering the campaigns, the system can easily extract a particular type of campaign data for training ML models and automate the process to reduce the long ML lifecycle, which improves efficacy.
Self-explainability: Unlike a detection system that is based on the content of a single URL, the discovered image, URL, and/or HTML patterns help explain the specific campaigns to which URLs or HTMLs belong. The system can also help to find the hidden tactics that are used to generate such campaigns, hence providing more evidence and explanation to the detection verdict.

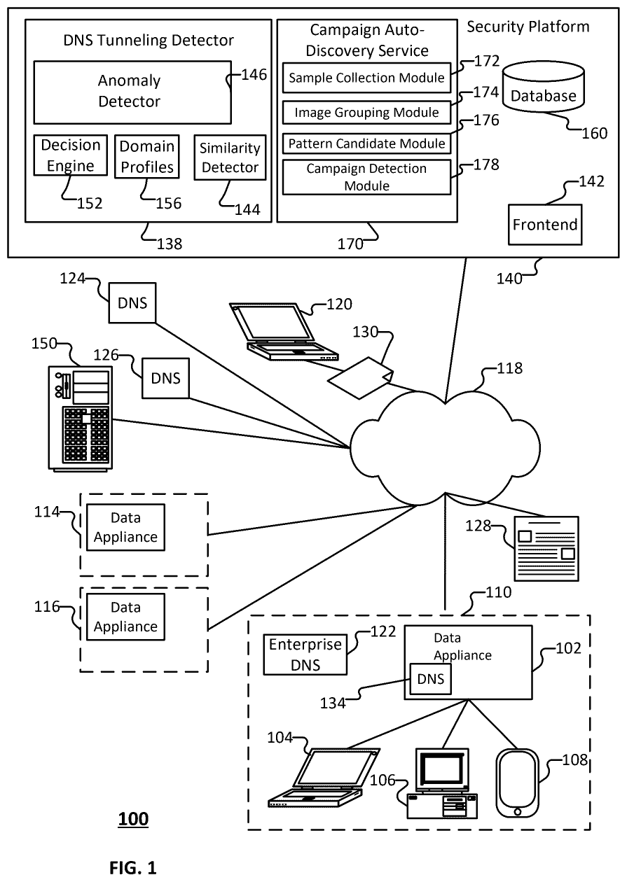

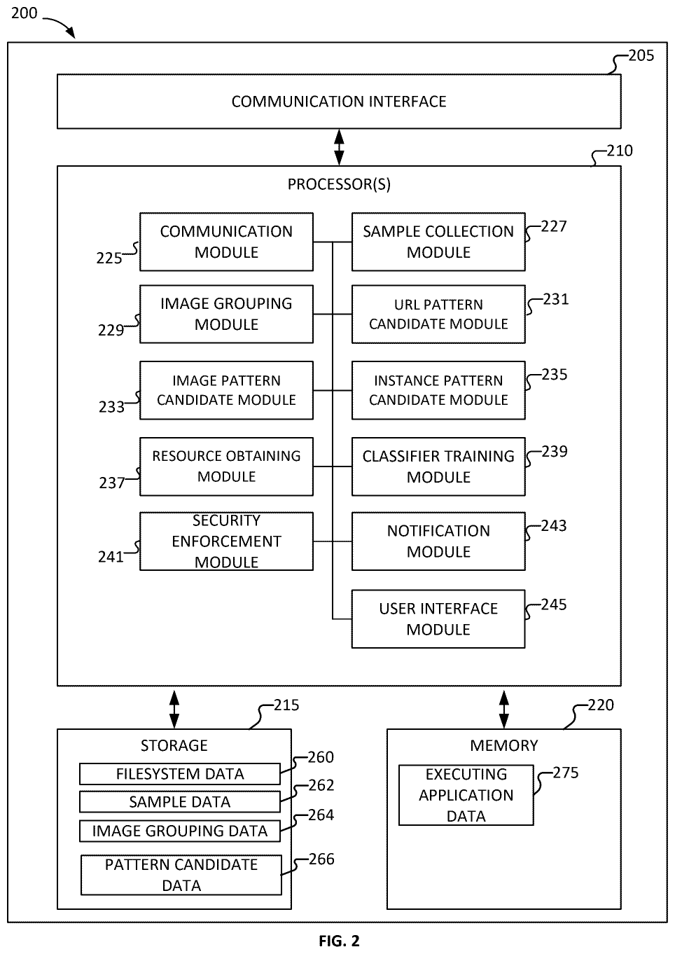

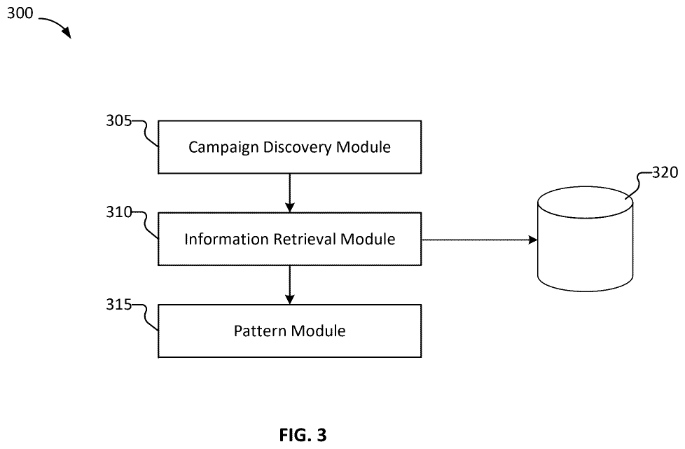

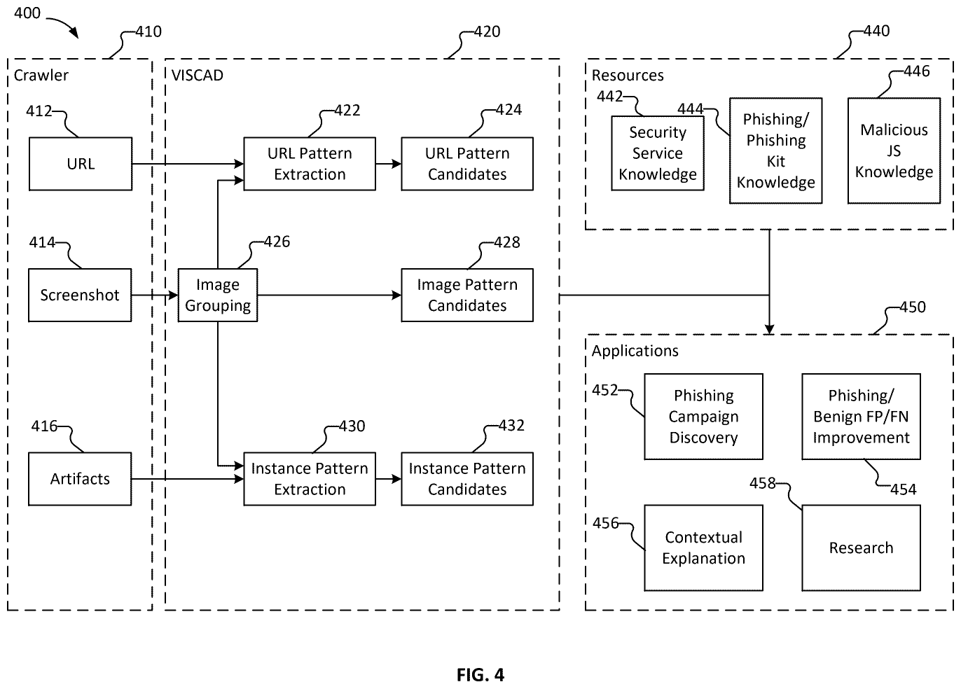

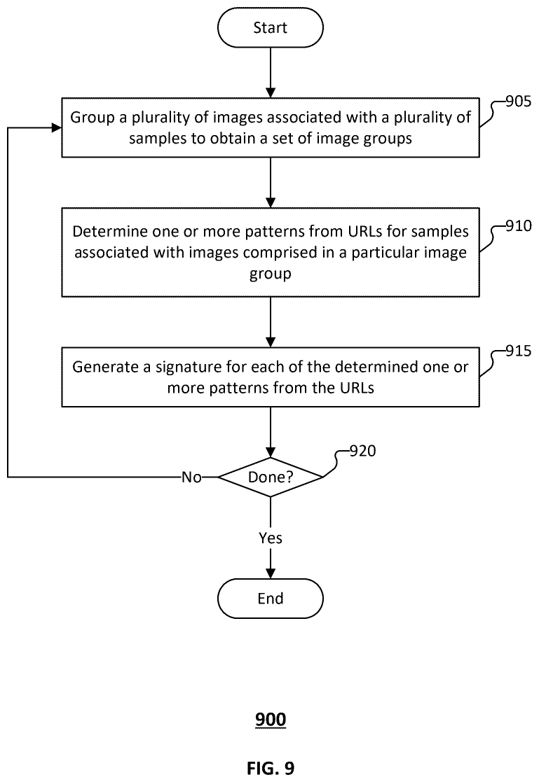

FIG. 1 is a block diagram of an environment in which a malicious domain is detected or suspected according to various embodiments. In some embodiments, system 100 is implemented by at least part of system 200 of FIG. 2, system 300 of FIG. 3, and/or system 400 of FIG. 4. In some embodiments, system 100 can implement one or more of processes 900-1600 of FIGS. 9-16.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains or parked domains, or traffic for certain applications (e.g., SaaS applications), or malicious or invalid authentication requests. In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including network security services, sample grouping (e.g., grouping domains), pattern candidate extraction, training/updating classifiers (e.g., machine learning models such as to provide a predicted maliciousness classification for samples, for example, domains), enforce one or more security policies, etc. Security platform 140 can use unsupervised data stored in a database (e.g., collected based on intercepting traffic communicated across a network) to identify patterns and train/update a model to detect emergent exploits (e.g., malicious domains, phishing campaigns, and the like). Security platform 140 can use images associated with the samples (e.g., the domains), such as screenshots of a webpage, to sort the samples into groupings from which security platform 140 can extract patterns and train/update the model.

According to various embodiments, examples of services provided by security platform 140 include (a) managing/maintaining a security policy configuration(s) for enterprise network 110 and/or devices connected to enterprise network 110 (e.g., managed devices, security entities, etc.), (b) enforcing the security policy configuration or causing a security entity (e.g., a firewall) to enforce the security policy configuration, (c) classifying network traffic, (d) classifying authentication requests and/or connection requests, (e) determining a manner by which authentication requests and/connection requests are to be handled (e.g., based at least in part on a predicted authentication classification, etc.), (f) training a machine learning (ML) model to generate predictions with respect to network traffic classifications, (g) grouping samples based on a set of corresponding images, (h) determining one or more URL candidate patterns based at least in part on a set of image groups, (i) determining one or more HTML candidate patterns based at least in part on the set of image groups, (j) determining one or more instance candidate patterns based at least in part on the set of image groups, (k) determining one or more image candidate patterns based at least in part on the set of image groups, and/or (l) performing an active measure with respect to network traffic (e.g., authentication requests) or files communicated across the network based on an instruction from another service or system or based on security platform 140 using a classifier (e.g., an ML model, a rule-based model, etc.) to generate a prediction with respect to the network traffic (e.g., a prediction of whether the network traffic, or session data for a particular traffic protocol, is malicious).

Security platform 140 may implement other services, such as determining an attribution of network traffic to a particular DNS tunneling campaign or tool, indexing features or other DNS-activity information with respect to particular campaigns or tools (or as unknown), classifying network traffic (e.g., identifying application(s) to which particular samples of network traffic corresponding, determining whether traffic is malicious, detecting malicious traffic, detecting C2 traffic, etc.), providing a mapping of signatures to certain traffic (e.g., a type of C2 traffic,) or a mapping of signatures to applications/application identifiers (e.g., network traffic signatures to application identifiers), providing a mapping of IP addresses to certain traffic (e.g., traffic to/from a client device for which C2 traffic has been detected, or for which security platform 140 identifies as being benign), performing static and dynamic analysis on malware samples, assessing maliciousness of domains, determining whether domains are parked domains, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain) or benign (e.g., an unparked domain), determining and/or providing an indication or a likelihood that authentication request is malicious, determining and/or providing an indication or a likelihood that network traffic for a particular traffic protocol (e.g., HTTP session data) is malicious, determining a model score, providing/updating a whitelist of input strings, files, domains, source addresses, destination address, authentication requests, or other characteristics or attributes of network traffic deemed to be benign, providing/updating input strings, files, domains, source addresses, destination address, authentication requests, or other characteristics or attributes of network traffic deemed to be malicious, identifying malicious input strings, detecting malicious input strings, detecting malicious files, predicting whether input strings, files, or domains are malicious, and providing an indication that an input string, file, or domain is malicious (or benign).

In some embodiments, campaign auto-discovery service 170 is a service for discovering exploits such as phishing campaigns. Campaign auto-discovery service 170 can use the discovered exploits to train or update a classifier (e.g., a machine learning model) to enhance the detection ability of the classifier. Campaign auto-discovery service 170 discovers exploits based on obtaining samples from database 160 (e.g., network traffic collected by a firewall or security platform 140), obtaining images for the samples (e.g., capture screenshots of images of webpages hosted by sample domains, obtain the images from database 160 based on querying the images based on the identifiers associated with the samples), and grouping the samples based on an image grouping. Security platform 140 can quickly group samples based on performing an image grouping. Such a grouping can be used a good representation of similar samples from which candidate patterns can be extracted (e.g., patterns with respect to the images, the URLs associated with the samples, the HTMLs associated with the samples, etc.).

Although the example shows that security platform 140 comprises campaign auto-discovery service 170, in various other embodiments, the campaign auto-discovery service 170 may be implemented by another server(s)/service.

Security platform 140 may be further configured to classify network traffic, such as to determine whether the traffic is malicious or benign, or to determine a likelihood that the traffic is malicious or benign. Security platform 140 can store one or more classifiers (e.g., rule-based models, machine learning models, etc.). For example, Security platform 140 implements a classifier for predicting whether authentication requests or connection requests (e.g., received from a proxy or client device) are malicious/benign. Security platform 140 can further store/implement one or more security policies, such as a traffic-handling policy, according to which security platform 140 causes the network traffic (e.g., the authentication requests) to be handled.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, campaign auto-discovery service 170 is implemented as a service to perform discovery (e.g., auto-discovery) of exploits (e.g., phishing campaigns), classifier training/updating, and/or sample classification (e.g., determining whether intercepted network traffic is malicious).

The techniques implemented by campaign auto-discovery service 170 speeds up the training or updating the classifier (e.g., the machine learning (ML) models). Usually when a system/administrator want to train an ML model, the system is required to perform data collection and data cleaning before training the ML model(s). However, data is oftentimes hard to obtain, particularly to obtain data for training a large ML model. Campaign auto-discovery service 170 can use image grouping and campaigns to quickly find similar looking features or characteristics from exploits (e.g., phishing campaigns). Security platform 140 can use the auto-discovery techniques to improve phishing detection, to perform phishing campaign and trend analysis, and to train a model for benign categorization/classification.

In some embodiments, campaign auto-discovery service 170 implements one or more techniques for extracting patterns, or candidate patterns, for sample groupings. The extracted patterns can then be used to train/update a classifier. In the example shown, campaign auto-discovery service 170 comprises sample collection module 172, image grouping module 174, pattern candidate module 176, and/or campaign detection module 178.

Campaign auto-discovery service 170 can use sample collection module 172 to collect samples and their associated data or characteristics, including, without limitation, images (e.g., screenshots of the corresponding webpages), URLs, HTMLs, and/or other artifacts. Sample collection module 172 can obtain the samples from database 160 which receives the samples during interception of network traffic by security platform 140 or by a firewall or other node in system 100.

Campaign auto-discovery service 170 uses image grouping module 174 to group samples based on their corresponding images. For example, image grouping module 174 performs a grouping of the images respectively associated with the collected samples in order to obtain a set of image groups.

In some embodiments, image grouping module 174 uses a hierarchical technique for grouping the images. Image grouping module 174 first more broadly or granularly groups the images to quickly group the images, such as to perform a coarse image grouping. Image grouping module 174 can perform this coarse image grouping by implementing a hashing method. For example, a perceptive hashing technique can be implemented to determine image hashes for the images associated with the collected samples. However, various other hashing techniques may be implemented. After broadly or granularly grouping the images, image grouping module 174 performs a refinement to obtain a set of refined image groups (e.g., the set of image groups to be used in connection with pattern extraction). Image grouping module 174 can implement a deep learning method to refine the image groupings (e.g., to obtain the set of refined images from the set of coarse groupings). The refinement of the image groupings can include merging similar looking groups (e.g., similar looking groups from the set of coarse groupings) to bigger groups. As an example, image grouping module 174 uses ResNet50 or other similar convolutional neural network to perform image encoding and refine the image groupings. Image grouping module 174 can implement various other pre-trained models (e.g., CNNs) for image encoding.

Campaign auto-discovery service 170 can use pattern candidate module 176 to determine (e.g., detect) patterns in the groups of samples (e.g., which are grouped according to the associated set of image groups). For example, pattern candidate module 176 determines one or more patterns manifested by the samples within a particular sample group (e.g., a set of samples comprising the samples associated with images in a particular image group). In some embodiments, the system determines, for a particular sample/image group, one or more image candidate patterns, URL candidate patterns, HTML candidate patterns, or other instance candidate patterns.

According to various embodiments, the pattern candidate module 176 can determine patterns in the URLs for a sample group (e.g., the URL candidate patterns) and/or patterns in the HTMLs for the sample group (e.g., the HTML or instance candidate patterns) based on performing clustering, pattern extraction, or feeding the URLs or HTMLs through a corresponding pattern mining pipeline. The system can implement a URL or HTML clustering using a heuristics-based clustering technique (e.g., using one or more predefined heuristics) and/or an ML/DL-based clustering technique (e.g., using a convolutional neural network (CNN) such as URLNet, etc.). The system can implement a pattern extraction with respect to the URLs or HTMLs based on a prefix tree, a generalized suffix tree, a wild-card detection (e.g., using one or more predefined wild-cards), and a random-string detector. As an example, within a particular image group, the pattern candidate module 176 can segment the corresponding URLs into separate clusters. Pattern candidate module 176 thus generates patterns based on an image group, and based on the image group the system can determine whether a pattern exists among the samples associated with the particular image group.

Campaign auto-discovery service 170 can use campaign detection module 176 to detect emergent exploits (e.g., phishing campaigns) or to associate newly detected patterns with known campaigns. Campaign detection module 176 can obtain (e.g., from database 160) various resource data that includes historical information pertaining to collected network traffic, historical sample classifications (e.g., domains deemed to be malicious or benign, etc.), known characteristics for malicious JavaScript (e.g., artifacts in the HTMLs for previously classified samples), known phishing campaign characteristics or artifacts, etc. Campaign detection module 176 can use the historical information to determine whether patterns associated with a particular image group are associated with a known campaign, or determine whether the patterns correspond to an emergent exploit. In some embodiments, campaign detection module 176 can compute signatures for the patterns or associated exploits/campaigns and correspondingly update a blacklist or whitelist, which can then be deployed to various firewalls across the network.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious samples, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding sample (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”)

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

FIG. 2 is a block diagram of a system to detect a malicious domain according to various embodiments. In some embodiments, system 200 is implemented by at least part of system 100 of FIG. 1, system 300 of FIG. 3, and/or system 400 of FIG. 4. In some embodiments, system 200 can implement one or more of processes 900-1600 of FIGS. 9-16. System 200 may be implemented in one or more servers, a security entity such as a firewall, an endpoint, a security service provided as a software as a service.

In some embodiments, system 200 is an entity that collects network traffic samples (e.g., domains) and determines one or more candidate patterns among the samples. System 200 can use the one or more candidate patterns to train a classifier (e.g., a machine learning model) to classify the samples, such as to predict whether a particular sample (e.g., a domain or webpage) is malicious or non-malicious. Additionally, or alternatively, system 200 may provide the one or more candidate patterns to another system or service to train a classifier. According to various embodiments, system 200 determines the one or more candidate patterns based at least in part on grouping the samples based on their associated images and analyzing each of the sample groupings (e.g., sample groups corresponding to the set of image groups).

In the example shown, system 200 implements one or more modules in connection with grouping samples based on their associated images (e.g., screenshots of the domains), determining candidate patterns, training a classifier, enforcing a security policy configuration (e.g., a policy for handling malicious traffic), classifying network samples, etc. System 200 comprises communication interface 205, one or more processor(s) 210, storage 215, and/or memory 220. One or more processors 210 comprises one or more of communication module 225, sample collection module 227, image grouping module 229, URL pattern candidate module 231, image pattern candidate module 233, instance pattern candidate module 235, resource obtaining module 237, classifier training module 239, security enforcement module 241, notification module 243, and user interface module 245.

In some embodiments, system 200 comprises communication module 225. System 200 uses communication module 225 to communicate with various nodes or end points (e.g., client terminals, firewalls, DNS resolvers, data appliances, other security entities, databases, etc.) or user systems such as an administrator system. For example, communication module 225 provides to communication interface 205 information that is to be communicated (e.g., to another node, security entity, etc.). As another example, communication interface 205 provides to communication module 225 information received by system 200, such as historical samples, trend data, capacity utilization data/logs, system activity, etc. Communication module 225 is configured to receive an indication of historical data (e.g., sample domains and their associated images/screenshots, URLs, HTMLs, etc.) to be analyzed and used to train a classifier (e.g., a malicious domain detector). Communication module 225 is configured to obtain, such as from client devices, remote databases, or other endpoints, samples to be classified or samples to be used to train a classifier. System 200 can use communication module 225 to obtain the samples from a database of unsupervised or unlabeled data. System 200 can use communication module 225 to query the third-party service(s) or other systems to obtain information to be used in connection with training a model (e.g., a malicious domain classifier), to generate and provide a request, and/or to determine or recommend an active measure to be implemented based on the forecast. Communication module 225 is further configured to receive one or more settings or configurations from an administrator.

In some embodiments, system 200 comprises sample collection module 227. System 200 uses sample collection module 227 to obtain samples to be used to train a classifier (e.g., samples to be grouped and for which patterns are to be determined) and/or candidate samples to be classified. Sample collection module 227 may be configured to obtain the samples from a database, such as a production database comprising historical network traffic analyzed or collected by a network security service (e.g., security platform 140 of system 100) or another node in the network (e.g., a firewall, etc.). Additionally, or alternatively, sample collection module 227 may be configured to obtain the samples directly from (e.g., processes running on) system nodes, such as firewalls, next generation firewall systems, client systems, servers, etc. As an example, sample collection module 227 obtains candidate samples from the system nodes in connection with a request for system 200 to classify the candidate sample (e.g., to determine whether the traffic is malicious, or the domain associated with the traffic is malicious and to determine whether to permit/restrict traffic based on the predicted classification).

In some embodiments, the sample data for a particular sample comprises an indication of the corresponding domain, an indication of the corresponding URL, an indication of the corresponding HTML, and/or a corresponding screenshot or image of the domain. System 200 may determine a sample domain based on querying the production database. In response to determining the sample domain, system 200 can use sample collection module 227 to access the domain, such as in an isolated environment (e.g., a sandbox), and thereafter capturing a screenshot and HTML for the sample domain.

In some embodiments, system 200 comprises image grouping module 229. System 200 uses image grouping module 229 to group images corresponding to a set of samples to be processed (e.g., for which patterns are to be determined and used for training/updating a classifier). Image grouping module 229 is configured to determine image groupings for a plurality of images based on a similarity of images. In some embodiments, image grouping module 229 groups the plurality of images based at least in part on image hashes computed with respect to the plurality of images and/or results from performing image encoding with respect to the plurality of images.

According to various embodiments, image grouping module 229 obtains (e.g., computes) image hashes for the plurality of images. Image grouping module 229 can implement a perceptive hashing technique (e.g., a hashing function that is relatively insensitive to low pitch information) to compute image hashes for the plurality of images. In response to obtaining the image hashes, image grouping module 229 can determine image groupings based on a similarity of the images computed based at least in part on the image hashes. For example, image grouping module 229 determines a coarse image groupings (e.g., a set of coarse groupings). Image grouping module 229 can use the image hashing technique to quickly assign images to groups.

According to various embodiments, image grouping module 229 obtains (e.g., computes) encoded images for the plurality of images. Image grouping module 229 performs (or queries another service to perform) an image encoding for the plurality of images. As an example, image grouping module 229 implements a convolutional neural network (CNN), such as ResNet50, to perform the image encoding. Image grouping module 229 uses the image encoding to refine the groups of samples, such as the coarse image groupings determined based on the image hashes.

In some embodiments, system 200 comprises URL pattern candidate module 231. System 200 uses URL pattern candidate module 231 to determine (e.g., extract) a set of patterns based on the URLs for the samples (e.g., the URL pattern candidates). URL pattern candidate module 231 obtains the set of image groups determined by image grouping module 229 and determines a set of patterns based on the URLs for the samples based on the image groups. For example, URL pattern candidate module 231 uses the set of image groups to define the grouping of samples for which URL pattern candidate module 231 is to perform pattern extraction. In response to obtaining the URLs for the samples associated with a particular image group, URL pattern candidate module 231 determines the patterns among the URLs for the samples associated with the particular image group.

According to various embodiments, URL pattern candidate module 231 performs pattern extraction based at least in part on one or more pattern extraction techniques, including, without limitation, a heuristics-based pattern extraction, a URLNet-based clustering/pattern extraction technique, a tree-based pattern extraction technique (e.g., a segmenting of the URLs and/or pattern stringing), a deep-learning or other machine learning-based clustering technique (e.g., to identify sub-clusters of samples for samples associated with a particular image group), or the feeding of the URLs through a URL pattern mining pipeline.

URL pattern candidate module 231 determines whether URLs for the samples within a particular image group can be segmented into separate clusters (e.g., sub-clusters). The URL pattern candidate module 231 generates patterns based on a particular image group for which URL pattern candidate module 231 analyzes samples. For example, URL pattern candidate module 231 determines if a URL string falls into one of the URL clusters and can be generalized.

System 200 uses the image grouping as a basis for performing pattern extraction for various sample groups because the image grouping is relatively inexpensive and efficient. Image grouping module 229 quickly determines reasonably good groupings of samples based on the image grouping, which in turn can be used to efficiently perform pattern extraction for patterns in the samples for a particular sample group.

In some embodiments, system 200 comprises image pattern candidate module 233. System 200 uses image pattern candidate module 233 to determine (e.g., extract) a set of patterns based on the images for the samples (e.g., the image pattern candidates). Image pattern candidate module 233 obtains the set of image groups determined by image grouping module 229 and determines a set of trending image patterns based on the statistical features of the image groups.

In some embodiments, system 200 comprises instance pattern candidate module 235. System 200 uses instance pattern candidate module 235 to determine (e.g., extract) a set of patterns based on the HTMLs for the samples (e.g., the HTML pattern candidates or instance pattern candidates). Instance pattern candidate module 235 obtains the set of image groups determined by image grouping module 229 and determines a set of patterns based on the HTMLs or other artifacts for the samples based on the image groups. For example, instance pattern candidate module 235 uses the set of image groups to define the grouping of samples for which instance pattern candidate module 235 is to perform pattern extraction. In response to obtaining the HTMLs or other artifacts for the samples associated with a particular image group, instance pattern candidate module 235 determines the patterns among the HTMLs or other artifacts for the samples associated with the particular image group.

According to various embodiments, instance pattern candidate module 235 performs pattern extraction based at least in part on one or more pattern extraction techniques, including, without limitation, a heuristics-based pattern extraction, a tree-based pattern extraction technique (e.g., a segmenting of the URLs and/or pattern stringing), a deep-learning or other machine learning-based clustering technique, or the feeding of the HTMLs through a HTML pattern mining pipeline.

Instance pattern candidate module 235 determines whether URLs for the samples within a particular image group can be segmented into separate clusters (e.g., sub-clusters). The instance pattern candidate module 235 generates patterns based on a particular image group for which instance pattern candidate module 235 analyzes samples. For example, instance pattern candidate module 235 determines if a URL string falls into one of the URL clusters and can be generalized.

In some embodiments, system 200 comprises resource obtaining module 237. System 200 uses resource obtaining module 237 to obtain resources pertaining to historical or third party sample classifications. Resource obtaining module 237 can obtain the resources from one or more databases, such as a production database comprising previously classified samples (e.g., samples for which system 200 implemented a classifier, such as a machine learning model, to predict a sample classification), etc. Resource obtaining module 237 can additionally obtain knowledge/information for known phishing campaigns/exploits, knowledge/information for known malicious JavaScript campaigns/exploits, etc. Resource obtaining module 237 may be configured to query a third party service, such as VirusTotal, to obtain information (e.g., a scoring) indicating whether certain samples (e.g., domains) are malicious.

In some embodiments, system 200 comprises classifier training module 239. System 200 uses classifier training module 239 to train and/or update a classifier that is configured to provide a predicted sample classification for a particular sample. The predicted sample classification can be a prediction of whether a particular sample is malicious or benign.

According to various embodiments, classifier training module 239 trains/updates a classifier based at least in part on one or more pattern candidates (e.g., a URL pattern candidate(s), an image pattern candidate(s), an HTML pattern candidate(s), or other instance pattern candidate(s)) and the resources. Classifier training module 239 uses the pattern candidates to associate a combination(s) of one or more pattern candidates to a classification, such as indication that the combination(s) of the one or more patterns is indicative of a sample (e.g., domain) being malicious or benign/non-malicious.

In some embodiments, system 200 comprises security enforcement module 241. System 200 uses security enforcement module 241 to enforce one or more security policies with respect to information such as network traffic, files, etc. In response to system 200 receiving samples (e.g., traffic) to be classified, system 200 uses a classifier to predict the sample classification, such as to predict whether the traffic is malicious (e.g., whether the traffic is to/from a malicious domain). For example, system 200 uses security enforcement module 241 to query a classifier (e.g., a classifier trained by classifier training module 239) to provide a predicted sample classification. Security enforcement module 241 may be configured handle the sample (e.g., handle the network traffic) based at least in part on the predicted classification

System 200 may use security enforcement module 241 to perform an active measure with respect to the network traffic in response to detecting that the sample (e.g., the intercepted network traffic or associated domain) is malicious. Security enforcement module 241 can determine the active measure to be implemented based on a mapping of sample classifications to active measures. For example, the active measure includes enforcing a particular security policy.

Security enforcement module 241 enforces the one or more security policies based on whether the candidate sample (e.g., the intercepted network traffic or associated domain) is malicious. As an example, in the case of system 200 being a security entity (e.g., a firewall) or firewall, system 200 comprises security enforcement module 241. Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. Other examples of policies include security policies such as ones requiring the scanning for threats in incoming (and/or outgoing) email attachments, website content, files exchanged through instant messaging programs, and/or other file transfers.

In some embodiments, system 200 comprises notification module 243. System 200 uses notification module 243 to provide indications pertaining to predicted sample classification (e.g., alerts that a malicious sample/traffic is detected), recommended active measurements, actions taken in enforcing one or more security policies, etc.

Notification module 243 may be configured to provide an indication of sample groupings, such as groupings determined based on an image grouping of images corresponding to collected samples. Additionally, notification module 243 may be configured to provide an indication of candidate patterns for the samples in a particular sample grouping. Examples of the candidate patterns may include one or more of URL candidate patterns, image candidate patterns, HTML candidate patterns, or other instance candidate patterns, etc.

In some embodiments, system 200 uses notification module 243 to provide an indication of a configuration for performing sample grouping (e.g., determining groups based on image information), a configuration for training a classifier, etc.

In some embodiments, system 200 comprises user interface module 245. System 200 uses user interface module 245 to configure and provide a user interface to a user, such as to a client system used by an administrator. User interface module 245 configures a user interface to provide the notifications or alerts, such as prompting the user of an active measure implemented based on the predicted classification, notifying the user of newly detected patterns, notifying the user of newly detected exploits (e.g., phishing campaigns), alerting the user that the training of the classifier (e.g., a sample classification model) is complete, prompting the user that a malicious traffic is detected or has been handled, prompting the user to select an active measure to be performed with respect to particular traffic, etc.

According to various embodiments, storage 215 comprises one or more of filesystem data 260, sample data 262, image grouping data 264, and pattern candidate data 266. Storage 215 comprises a shared storage (e.g., a network storage system) and/or database data, and/or user activity data.

In some embodiments, filesystem data 260 comprises a database such as one or more datasets. Examples of datasets include datasets containing information pertaining to network activity, system activity, network services, network security services, network or system configurations, defined policies or policies implemented by a service (e.g., a network security service), etc. Filesystem data 260 comprises data such as historical information pertaining to HTTP request data or network traffic, network activity, network service data, security service traffic/activity, a whitelist of network traffic profiles (e.g., hashes or signatures for the HTTP request data) or IP addresses deemed to be safe (e.g., not suspicious, benign, etc.), a blacklist of network traffic (e.g., authentication request) profiles deemed to be suspicious or malicious, etc.

In some embodiments, sample data 262 comprises data pertaining to one or more samples, such as network traffic samples. The samples may be an indication of a domain associated with network traffic, such as network traffic collected by a network security service that provides network security services for an enterprise network. For a particular sample, the sample data 262 may include an indication of the domain, an indication of the URL, an image or screenshot (e.g., a screenshot of the webpage hosted at the domain/URL), part or all of the HTML for the domain/URL, etc. Sample data 262 may be unsupervised data that is collected during production of a network security service.

In some embodiments, image grouping data 264 comprises data pertaining to one or more images for samples to be processed by 200. The image grouping data 265 may comprise the screenshots or images for the samples, image hashes for the images for the samples, results from image encoding the images for the samples, an indication of a similarity between or among two or more images, an indication of a set of image groups (e.g., a coarse image groupings, a refined image groupings, etc.).

In some embodiments, pattern candidate data 266 comprises an indication of one or more patterns associated with one more sample groups, such as groups defined by a set of one or more image groups. Pattern candidate data 266 can include one or more patterns among samples with a particular sample group. Examples of the patterns include URL candidate patterns (e.g., patterns based on the URLs for the samples), image candidate patterns (e.g., patterns based on the images for the samples), HTML candidate patterns (e.g., patterns based on the HTML for the samples), or other instance candidate patterns. In some embodiments, pattern candidate data 266 comprises results from clustering samples, such as a clustering of samples associated with images within a particular image group.

According to various embodiments, memory 220 comprises executing application data 275. Executing application data 275 comprises data obtained or used in connection with executing an application such as an application for training a forecast model, an application for using a forecast model to generate a forecast, an application executing a hashing function (e.g., an application to perform perceptive hashing on an image), an application executing an image encoding, an application for grouping samples (e.g., determining image groupings), an application to extract information from connection requests, authentication requests, webpage content, an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious authentication requests, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIG. 3 is an illustration of a system for detecting a malicious domain according to various embodiments. In the example shown, system 300 comprises campaign discovery module 305, an information retrieval module 310, pattern module 315, and database 320. Campaign discovery module 305 can determine a campaign based on the analysis of a set of samples, such as sample network traffic collected by a security service, to determine whether emergent campaigns can be detected, or other patterns can be associated with known campaigns. Campaign discovery module 305 can determine to perform the campaign discovery based on a predefined schedule or frequency, or in response to determining that a discovery criteria is satisfied (e.g., that the number of collected and unanalyzed samples exceeds a predefined threshold). In response to determining to perform campaign discovery, campaign discovery module 305 can cause information retrieval module 310 to collect the samples from database 320. For example, information retrieval module 310 can collect domains from database 320 and obtain corresponding images, URLs, HTMLs, or other artifacts. In some embodiments, information retrieval module 310 obtains the images, HTMLs, or other artifacts by causing a domain to be accessed within an isolated environment. In response to obtaining the requisite information, campaign discovery module 305 can cause pattern module 315 to detect any patterns within the set of collected samples.

In some embodiments, pattern module 315 detects patterns within the set of collected samples based at least in part on grouping the samples according to an image grouping. For example, pattern module 315 groups the images for the collected samples based on one or more of a grouping based on image hashes (e.g., results from performing an image hashing on the images) and/or a grouping or refinement of groups based on image encoding. In response to grouping the samples according to image grouping, pattern module 315 analyzes each group of samples to determine whether any patterns can be extracted from the constituent samples. For example, pattern module 315 determines whether the samples within the selected sample group have any URL patterns, HTML patterns, image patterns, or other artifact patterns.

In response to determining candidate patterns, system 300 can use the patterns to detect new exploits/campaigns or to detect new patterns to be associated with known exploits/campaigns.

FIG. 4 is a block diagram of a system for training or using a classifier to classify images based on patterns derived from a set of samples based on image grouping according to various embodiments. In the example shown, system 400 comprises a plurality of services, including crawler service 410, VisCAD service 420, resources service 440, and applications service 450. Each of the services may be implemented by one or more compute resources, such as a set of one or more servers, or virtual machines running in a cluster, etc.

System 400 uses crawler service 410 that obtains information pertaining to samples, such as domains for intercepted network traffic. Crawler service 410 can obtain the information directly from the intercepted network traffic or by accessing the domain or network traffic such as in an isolated environment (e.g., a sandbox). Crawler service 410 uses URL crawler 412 to obtain the URL for a sample (e.g., the set of samples to be analyzed by VisCAD service 420). Crawler service 410 uses screenshot service 414 to capture a screenshot or other image for the domain, such as a screenshot of the webpage hosted at the domain. Crawler service 410 uses artifacts service 416 to obtain the HTML for the domain (e.g., the HTML of the webpage hosted at the domain), or other artifacts associated with the domain.

System 400 uses VisCAD service 420 to perform discovery (e.g., auto-discovery) of exploits/campaigns. For example, VisCAD service 420 implements a visual-guided campaign auto-discovery. VisCAD service 420 uses image grouping service 426 to group the samples based at least in part on the images obtained by screenshot service 414. Image grouping service 426 determines the set of image groups based on the techniques described herein, including based on similarity among images. The set of image groups are used by image pattern candidates service 428 to determine, for a particular image group, one or more patterns among images in the image group.

As illustrated, VisCAD service 420 additionally uses the set of image groups to inform the pattern discovery for URL patterns and HTML or instance patterns.

For example, VisCAD service 420 inputs the set of image groups and the sets of URLs respectively corresponding to the set of image groups to URL pattern extraction service 422. For a particular image group (or a sample group for samples associated with images in the particular image group), URL pattern extraction service 422 performs pattern extraction among those URLs for the samples associated with the particular image group. The pattern extraction can be performed in accordance with the techniques described herein, including one or more of a URL clustering technique (e.g., a heuristics-based technique or a ML/DL-based technique), a tree-based technique, a wild-card-based technique, a random string detector-based technique, or other pattern mining pipeline. URL pattern candidates service 424 identifies the patterns associated with the URLs corresponding to the samples associated with the images in the particular image group.

As example, VisCAD service 420 inputs the set of image groups and the sets of artifacts (e.g., HTMLs) respectively corresponding to the set of image groups to instance pattern extraction service 430. For a particular image group (or a sample group for samples associated with images in the particular image group), instance pattern extraction service 430 performs pattern extraction among those artifacts (e.g., HTMLs) for the samples associated with the particular image group. The pattern extraction can be performed in accordance with the techniques described herein, including one or more of an artifact/HTML clustering technique (e.g., a heuristics-based technique or a ML/DL-based technique), a tree-based technique, a wild-card-based technique, a random string detector-based technique, or other pattern mining pipeline. Artifact pattern candidates service 432 identifies the patterns associated with the artifacts (e.g., HTMLs) corresponding to the samples associated with the images in the particular image group.

System 400 uses resource service 440 to obtain resource data from various datasets. The resource data includes historical information pertaining to collected network traffic, historical sample classifications (e.g., domains deemed to be malicious or benign, etc.), known characteristics for malicious JavaScript (e.g., artifacts in the HTMLs for previously classified samples), known phishing campaign characteristics or artifacts, etc. For example, resources service 440 can obtain resource data from security service knowledge service 442 (e.g., a database of historical information collected by a security service), phishing/phishing kit knowledge service 444 (e.g., a database of characteristics associated with known phishing campaigns), and/or malicious JavaScript (JV) knowledge service 446 (e.g., a database of characteristics of various HTML exploits or JV exploits, etc.).

System 400 uses applications service 450 to obtain the pattern candidates (e.g., URL pattern candidates, image pattern candidates, HTML or other instance pattern candidates) from VisCAD service 420 and the resource data from resources service 440 to perform one or more services pertaining to the detection of malicious traffic or phishing campaigns.

Applications service 450 comprises phishing campaign discovery service 452 that discovers emergent/new phishing campaigns based on the pattern candidates and the resource data.

Applications service 450 comprises phishing/benign false positive (FP)/false negative (FN) improvement service 454 that updates a classifier to detect known exploits/phishing campaigns based at least in part on the pattern candidates and the resource data.

Applications service 450 comprises contextual explanation service 456 that determines a context of phishing campaign discovery, such as associating patterns or combination of patterns that are indicative of malicious or benign samples. Examples of contextual information collected include an indication of the particular campaign the detection is from (e.g., campaign with which the pattern or combination of patterns is associated), the pattern, the source information, etc. This contextual information may assist users in explaining why certain domains are classified as malicious or benign, etc. An example set of contextual information for a campaign includes (i) a set of URLs implementing the campaign (e.g., (a) https://pub-3e529a6ea6dd4ae095fad18e37160d3a.r2.dev/roundcube.html#s.ahmed@dalgroup.com; (b) http://pub-9d425aa9335c4307a502c0721d499bdd.r2.dev/Roundcu.html?email=zps@zoner.de; (c) pub-9d425aa9335c4307a502c0721d499bdd.r2.dev/Roundcu.html?email=watanabe.tsune mi@kochi-tech.ac.jp); (ii) an indication of the discovered campaign pattern (e.g., https://pub-.*r2.dev/.*.html?email=.*); (iii) domain information (e.g., an indication that r2.dev not reachable, the corresponding WhoIS registration shows “Redacted for Privacy”, the domain has 10 k+ children with greater than 50% of such children corresponding to malware or phishing campaigns); (iv) an indication of the context for the campaign (e.g., these pages try a similar Microsoft login page to lure the user to input passwords); and (v) additional information (e.g., additional links or resources for the corresponding campaign).

Applications service 450 comprises research service 458 that performs research for campaign discovery or malicious/benign traffic classification based at least in part on the patterns or combination of patterns and resource data.

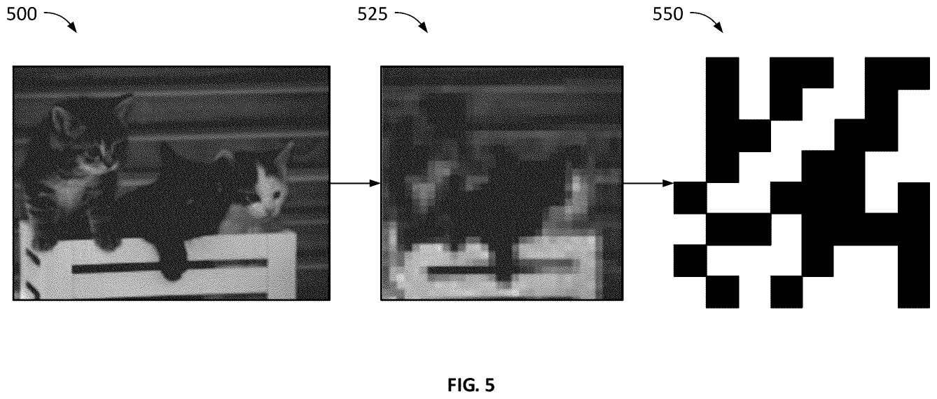

FIG. 5 is an example of hashing an image according to various embodiments. In the example shown, the system performs image hashing (e.g., perceptive hashing) with respect to image 500 to obtain gray and downscaled sample 525. The system obtains image hash 550 based at least in part on computing the discrete cosine transform (DCT) of gray and downscaled sample 525 to obtain image hash 550. In some embodiments, image hash 550 is obtained by computing the DCT of gray and downscaled sample 525, discarding all components of the DCT except the upper-left 8×8 portion, determining the median value of the reduced DCT, and for each bit in the output hash, setting it to 1 if the corresponding component of the reduced DCT is greater than the median, or 0 otherwise.

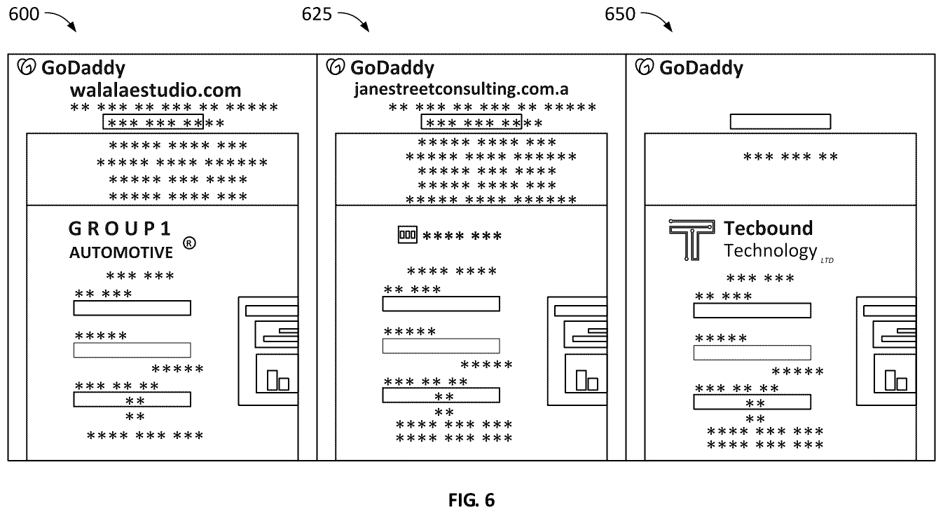

FIG. 6 is a set of screenshots grouped based on image encoding according to various embodiments. In the example shown, the system can analyze a set of samples based on their corresponding screenshots 600, 625, and 650. The screenshots 600, 625, and 650 may be grouped into a single image group for which pattern extraction is performed. In some embodiments, the system determines whether to group screenshots 600, 625, and 650 into a single image group based at least in part on performing image encoding (e.g., using a pretrained model, such as ResNet50) with respect to screenshots 600, 625, and 650.

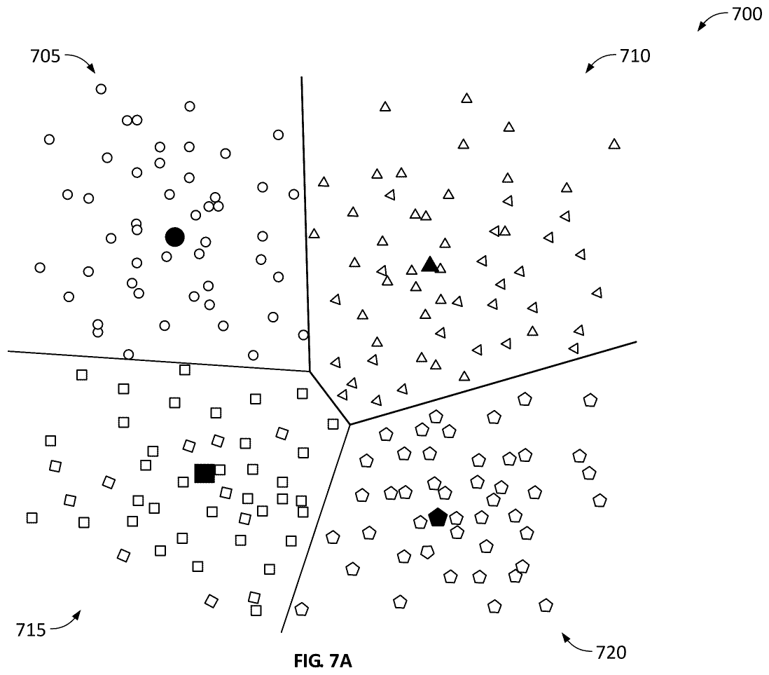

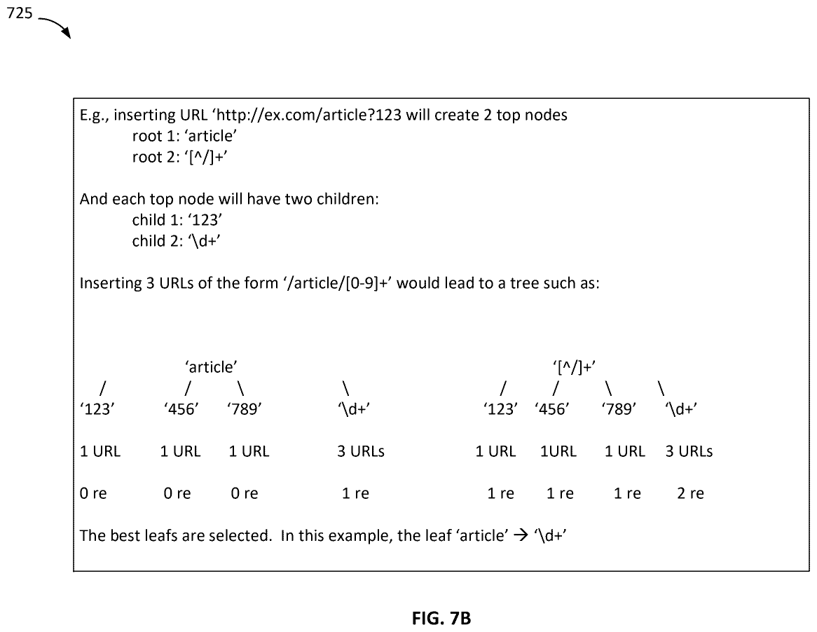

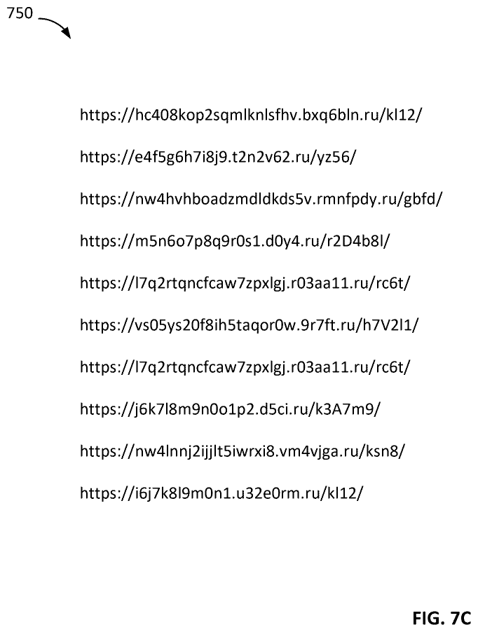

FIG. 7A is an example of a clustering of a set of samples using a URLNet-based model according to various embodiments. In the example shown, the system performs a clustering with respect to samples within a particular image group to determine sub-clusters from which patterns may be extracted. Clustering result 700 illustrates an image group clustered into sub-clusters 705, 710, 715, and 720.

FIG. 7B is an example of clustering a set of samples using a tree-based model according to various embodiments. The system can perform pattern extraction with respect to URLs in an image group by performing a tree-based pattern extraction. The system generates tree 725 by breaking down URL segments into a tree path. The tree path follows some regex patterns that merge into a parent branch. A successful tree-based pattern extraction tries the best reduction, so each regex is not too general. For example, the system tries to find the minimum reduction along a path of URL so generated patterns are not so broad.

FIG. 7C is an example of URLs for which the system determines a set of patterns according to various embodiments. Based on performing the pattern extraction techniques after performing image grouping, the system can detect patterns within a set of domains 750.

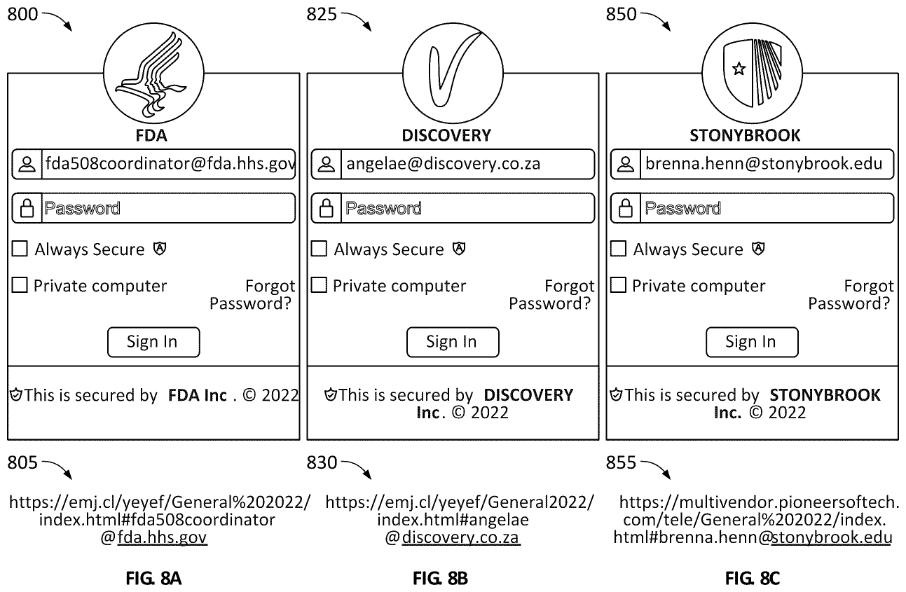

FIGS. 8A-8C are a set of brand spoofing attacks detected by a visual-guided campaign auto-discovery (VisCAD) service or technique according to various embodiments. The system can extract patterns and detect phishing campaigns (e.g., emergent/new campaigns, or newly identified patterns for known campaigns) based on performing image grouping and the pattern extraction techniques disclosed herein. Screenshots 800, 825, and 850 are examples of brand spoofing campaigns for which the system can detect URL candidate patterns and/or HTML candidate patterns after being grouped into a particular image group. The campaign for which screenshots 800, 825, and 850 are captured is a phishing campaign that automatically changes favicon and brand name. The campaign blinds a click event handler with submit-btn that prevents default form submission behavior. Example URLs with a discovered pattern include (a) https://emj.cl/yeyef/General%202022/index.html#[email]; (b) https://homedeliverybr.com/aust/General 2022/index.html#[email]; and (c) https://multivendor.pioneersoftech.com/tele/General%202022/index.html#[email].

FIG. 9 is a flow diagram of a method for determining patterns in URLs for samples according to various embodiments. In some embodiments, process 900 is implemented at least in part by system 100 of FIG. 1 and/or system 200. Process 900 may be implemented by an inline security entity, or a cloud security entity or service.

In some implementations, process 900 may be implemented by one or more servers, such as in connection with providing a service to a network (e.g., a security entity and/or a network endpoint such as a client device). In some implementations, process 900 may be implemented by a security entity (e.g., a firewall) such as in connection with enforcing a security policy with respect to traffic from/to domains across a network or in/out of the network.

At 905, the system groups a plurality of images associated with a plurality of samples to obtain a set of image groups. The system groups a set of samples into a set of groups based at least in part on images associated with the samples. The images may be screenshots for webpages associated with the samples. In response to obtaining the images for the set of samples, the system processes the images, determines similarities associated with the images, and groups the images based at least in part on the similarities associated with the images.

In some embodiments, the system processes the images for the set of samples in connection with determining image groupings and/or sample groupings. The processing of the images may include performing an image hashing and/or an image encoding. An example of a hashing technique includes Perceptual Image Hashing. An example of an image encoding technique includes processing the images using a ResNet-50 (e.g., a convolutional neural network) to encode images for similarity matching. Various other hashing and/or encoding techniques may be implemented. The system can determine a coarse image groupings (e.g., a set of coarse groupings, or a first grouping of a plurality images) based at least in part on image hashes (e.g., obtained by perceptive hashing) for the images associated with the set of samples. In response to determining the coarse image groupings, the system can refine the coarse image groupings based at least in part on an image encoding (e.g., obtained by performing a deep learning or machine learning process). For example, the system uses image hashing to assign images to groups, and uses deep learning to refine the groups. In some embodiments, the refining of the coarse image groupings includes merging similar coarse image groups. The refining of the coarse image groupings may further include (or alternatively include) splitting coarse image groups into a set of smaller image groups (e.g., identifying dissimilarities among subsets of coarse image groups).

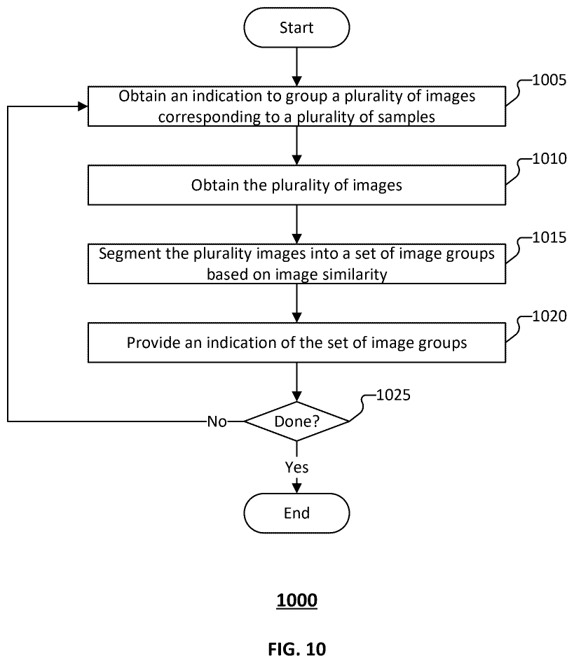

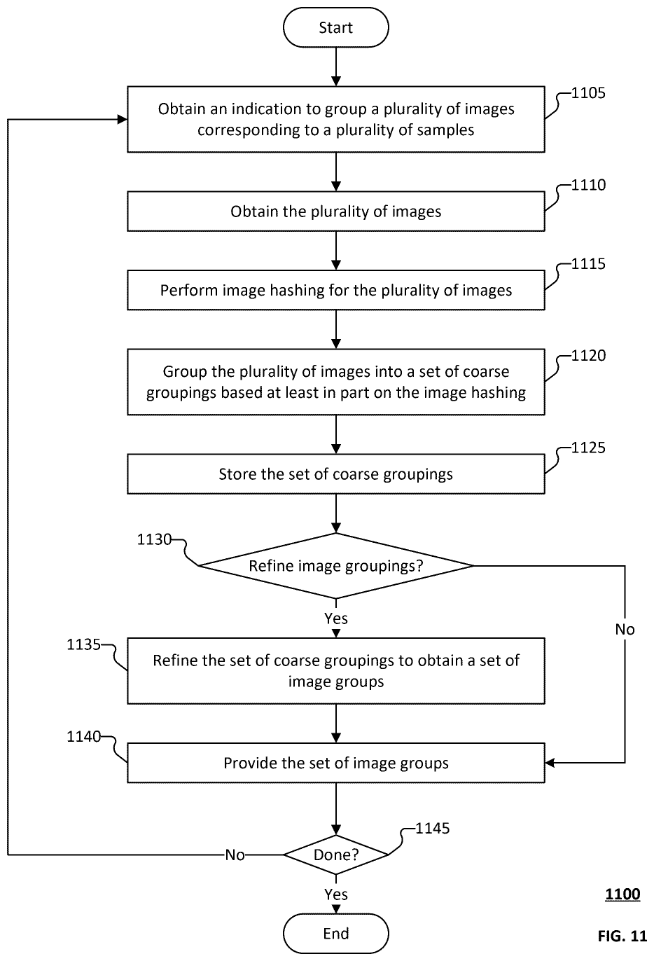

In some embodiments, the grouping of the plurality of images comprises invoking process 1000 of FIG. 10. Additionally, or alternatively, the system implements, or causes another system or service to implement, process 1100 of FIG. 11 and/or process 1200 of FIG. 11.

At 910, the system determines one or more patterns from URLs for samples associated with images comprised in a particular image group. The system uses the set of image groups to obtain the URLs for each image in a particular image group, and uses the corresponding set of URLs to identify any patterns across the URLs associated with the samples in the image group.

According to various embodiments, the system determines the one or more patterns from URLs for samples in a particular image group based on performing clustering, pattern extraction, or feeding the URLs through a URL pattern mining pipeline. The system can implement a URL clustering using a heuristics-based clustering technique (e.g., using one or more predefined heuristics) and/or an ML/DL-based clustering technique (e.g., using a convolutional neural network (CNN) such as URLNet, etc.). The system can implement a pattern extraction with respect to the URLs based on a prefix tree, a generalized suffix tree, a wild-card detection (e.g., using one or more predefined wild-cards), and a random-string detector.

In some embodiments, the system processes each image group to obtain the URLs for the corresponding samples (e.g., by obtaining the URLs from the samples associated with the image or screenshot) and to determine any patterns in the URLs for the particular image group.

At 915, the system generates a signature for each of the determined one or more patterns for the URLs. In some embodiments, the system implements a predefined signature generation technique to determine a signature for a particular pattern. For example, the system implements a hashing technique to hash the pattern (e.g., the characters/string comprised in the pattern) to obtain the signature. Examples of a hashing technique or algorithm that may be implemented include: MD-5, SHA-256, RIPEMD-160, and Whirlpool. However, various other hashing techniques or other signature generation processes may be implemented.

At 920, a determination is made as to whether process 900 is complete. In some embodiments, process 900 is determined to be complete in response to a determination that no further signatures are to be determined for patterns, no further patterns for the set of image groups are to be analyzed or processed, no further image groups are to be processed, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for determining a set of image groups for a set of samples according to various embodiments. In some embodiments, process 1000 is implemented at least in part by system 100 of FIG. 1 and/or system 200. Process 1000 may be implemented by an inline security entity, or a cloud security entity or service.

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to traffic from/to domains across a network or in/out of the network.

In some embodiments, process 1000 is invoked by process 900 of FIG. 9, such as at 905 of process 900.

At 1005, the system obtains an indication to group a plurality of images corresponding to a plurality of samples. The system can determine to group the plurality of images in response to identifying samples stored in a database, such as a production database that is used to store samples collected during the provision of a network security service. For example, firewalls, next generation firewalls, cloud security services, or other nodes within a network can collect samples from traffic communicated across a network. The samples stored in the database may correspond to unsupervised data.

In some embodiments, the system analyzes unsupervised data in the database to retrieve information that can be used to detect exploits, such as to recognize patterns in one or more of images, URLs, or HTMLs for the samples stored in the database. The system can analyze the data in the database according to a predefined schedule or frequency, or upon satisfaction of an analysis criteria. The system (e.g., the VisCAD platform/system) can efficiently and quickly process the data to derive patterns in the samples that can be used to quickly and accurately classify new samples, such as in the context of network security, to classify traffic as malicious or benign/non-malicious.

In some embodiments, the system obtains the indication to obtain the group of the plurality of images from the system or service implementing 905 of process 900.

At 1010, the system obtains the plurality of images. The system obtains the images from the database of samples, for example, the corresponding images may be stored in association with the samples (e.g., in association with the other data for the samples such as URL, HTML, etc.). Additionally, or alternatively, the system can obtain the URLs for the samples and access the URLs within a controlled environment (e.g., a sandbox) during which the system captures a screenshot of the page hosted at the URL.

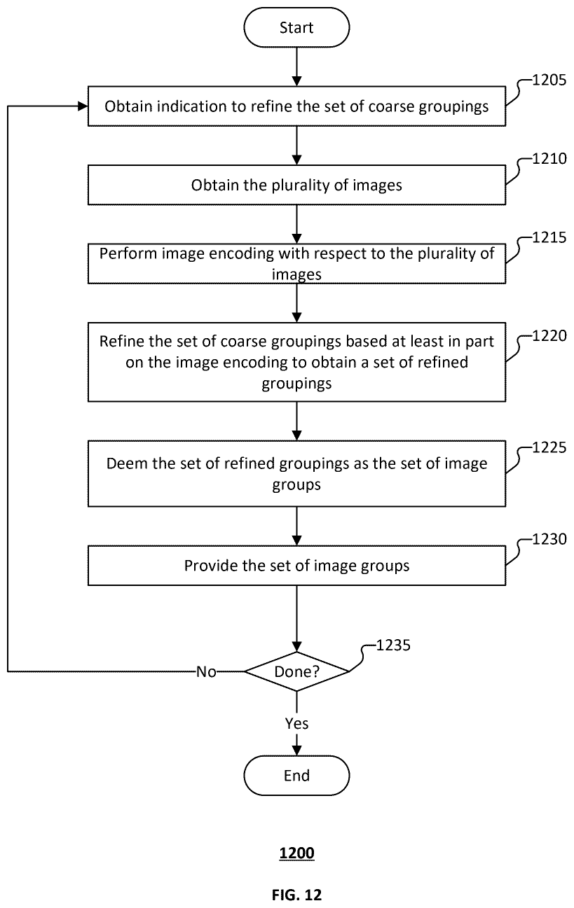

At 1015, the system segments the plurality of images into a set of image groups based at least in part on an image similarity. The system processes the plurality of images to determine similarities among various groups of images. In some embodiments, processing the plurality of images includes performing an image hashing (e.g., a perceptive hashing) and/or an image encoding. The system can use the image hashes or encoded images to detect similarities and group the set of images into the set of image groups. In some embodiments, the processing of the plurality of images includes invoking one or more of process 1100 of FIG. 11 and/or process 1200 of FIG. 12.

At 1020, the system provides an indication of the set of image groups.

At 1025, a determination is made as to whether process 1000 is complete. In some embodiments, process 1000 is determined to be complete in response to a determination that no further samples are to be processed, each sample has been assigned to a particular image group, no further image groups are to be processed, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for determining a set of image groups for a set of samples according to various embodiments. In some embodiments, process 1100 is implemented at least in part by system 100 of FIG. 1 and/or system 200. Process 1100 may be implemented by an inline security entity, or a cloud security entity or service.

In some implementations, process 1100 may be implemented by one or more servers, such as in connection with providing a service to a network (e.g., a security entity and/or a network endpoint such as a client device). In some implementations, process 1100 may be implemented by a security entity (e.g., a firewall) such as in connection with enforcing a security policy with respect to traffic from/to domains across a network or in/out of the network.

At 1105, the system obtains an indication to group a plurality of images corresponding to a plurality of samples. At 1110, the system obtains the plurality of images. At 1115, the system performs image hashing for the plurality of images. At 1120, the system groups the plurality of images into a set of coarse groupings based at least in part on the image hashing. For example, the system identifies similar images (e.g., images having a similarity greater than a predefined similarity threshold) and groups those similar images into a particular coarse image group. In some embodiments, the hashing algorithm/technique implemented is relatively insensitive to low pitch information. At 1125, the system stores the set of groupings. At 1130, the system determines whether to refine the image groupings. In some embodiments, the system determines to refine the image groupings if a similarity among images in a particular coarse image grouping (e.g., in any of the set of coarse groups) is less than a predefined similarity threshold. In other implementations, the system is configured to refine the set of coarse groupings, such as by implementing an image encoding and detecting similarity of the images based on the image encoding. The image encoding may be relatively insensitive to high pitch information. In response to determining that a refinement of the image groupings is not to be performed, process 1100 proceeds to 1140. Conversely, in response to determining that a refinement of the image groupings is to be performed, process 1100 proceeds to 1135. At 1135, the system refines the set of coarse groupings to obtain a set of image groups. In some embodiments, the system invokes process 1200 to refine the set of coarse groupings. At 1140, the system provides the set of image groups. In some embodiments, if the coarse groupings are refined, then the set of image groups is the refined image groupings determined based on refining the coarse groupings. If the system refines the coarse groupings, then the set of images corresponds to the coarse groupings (or a subset of the set of coarse groupings). At 1145, a determination is made as to whether process 1100 is complete. In some embodiments, process 1100 is determined to be complete in response to a determination that no further samples (e.g., images) are to be processed, each sample has been assigned to a particular image group, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for refining a set of image groups according to various embodiments. In some embodiments, process 1200 is implemented at least in part by system 100 of FIG. 1 and/or system 200. Process 1200 may be implemented by an inline security entity, or a cloud security entity or service.

In some implementations, process 1200 may be implemented by one or more servers, such as in connection with providing a service to a network (e.g., a security entity and/or a network endpoint such as a client device). In some implementations, process 1200 may be implemented by a security entity (e.g., a firewall) such as in connection with enforcing a security policy with respect to traffic from/to domains across a network or in/out of the network.

In some embodiments, process 1200 is invoked by process 1100 of FIG. 11, such as at 1135 of process 1100.

At 1205, the system obtains an indication to refine the set of coarse groupings. At 1210, the system obtains the plurality of images. Additionally, the system can obtain an indication of the set of coarse groupings. At 1215, the system performs image encoding with respect to the plurality of images. At 1220, the system refines the set of coarse groupings based at least in part on the image encoding to obtain a set of refined groupings. For example, the system uses results from the image encoding to modify the set of coarse groupings, such as to merge coarse image groups, or to further split the coarse image groups. The system further determines a similarity among images using the image encoding and determines a manner in which to update the set of coarse groupings based on the similarity between images or sets of images comprised in different coarse image groupings. At 1225, the system deems the set of refined groupings as the set of image groups. At 1230, the system provides the set of image groups. At 1235, a determination is made as to whether process 1200 is complete. In some embodiments, process 1200 is determined to be complete in response to a determination that no further samples (e.g., images) are to be processed, each sample has been assigned to a particular image group, an administrator indicates that process 1200 is to be paused or stopped, etc. In response to a determination that process 1200 is complete, process 1200 ends. In response to a determination that process 1200 is not complete, process 1200 returns to 1205.

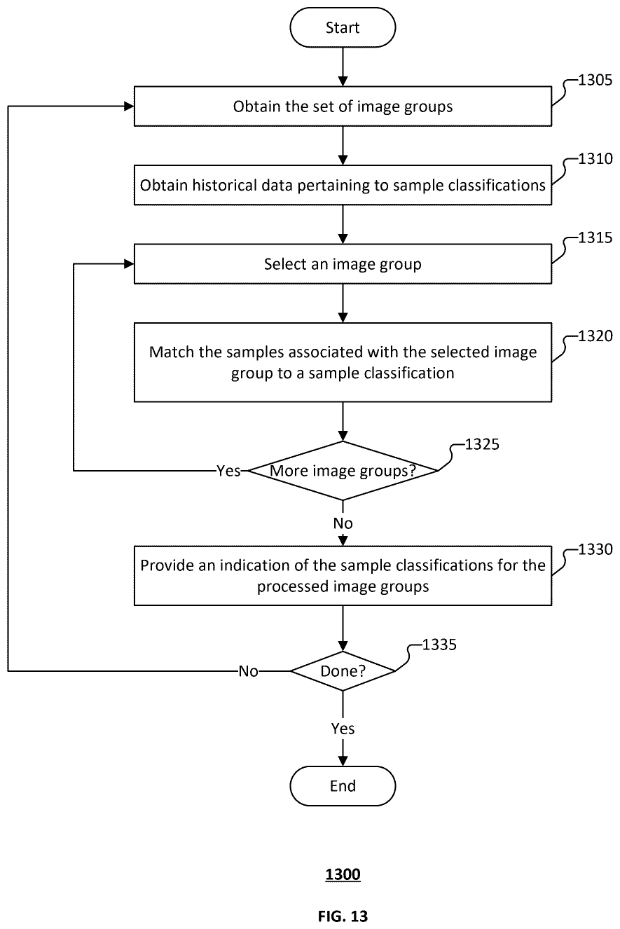

FIG. 13 is a flow diagram of a method for matching a set of samples with a set of sample classifications according to various embodiments. In some embodiments, process 1300 is implemented at least in part by system 100 of FIG. 1 and/or system 200. Process 1300 may be implemented by an inline security entity, or a cloud security entity or service.

In some implementations, process 1300 may be implemented by one or more servers, such as in connection with providing a service to a network (e.g., a security entity and/or a network endpoint such as a client device). In some implementations, process 1300 may be implemented by a security entity (e.g., a firewall) such as in connection with enforcing a security policy with respect to traffic from/to domains across a network or in/out of the network.

At 1305, the system obtains the set of image groups. For example, the system obtains the set of image groups from 1140 of process 1100. At 1310, the system obtains historical data pertaining to sample classifications. At 1315, the system selects an image group. Alternatively, the system selects a set of samples corresponding to a particular image group. At 1320, the system matches the samples associated with the selected image group to a sample classification(s). For example, the system determines one or more patterns associated with the samples for the selected image group (e.g., patterns in the images, the URLs, and/or the HTMLs for the samples) and uses the one or more patterns associated with the samples to match the samples for the image sample group to a sample classification, such as a classification that indicates whether the sample if malicious or benign/non-malicious. At 1330, the system determines whether more image groups are to be processed. For example, the system determines whether to determine sample classifications that are associated with one or more patterns determined based at least in part on the image group. The system determines one or more patterns derived from a particular image group (e.g., patterns manifested by the samples in the image group) and associates the one or more patterns with the particular image group, such as to facilitate the classification of samples within the image group or having the same/similar one or more patterns associated with the image group. In response to determining that more image groups are to be processed, process 1300 returns to 1315 and process 1300 iterates over 1315-1325 until no further image groups are to be processed. At 1330, the system provides an indication of the sample classifications for the processed image groups. At 1335, a determination is made as to whether process 1300 is complete. In some embodiments, process 1300 is determined to be complete in response to a determination that no further samples (e.g., images) are to be processed, no further sample classifications are to be associated with the processed imaged groups, each pattern or set/combination of patterns comprised in (e.g., manifested by) an image group or a sample that belongs to the image has been matched to a sample classification, an administrator indicates that process 1300 is to be paused or stopped, etc. In response to a determination that process 1300 is complete, process 1300 ends. In response to a determination that process 1300 is not complete, process 1300 returns to 1305.

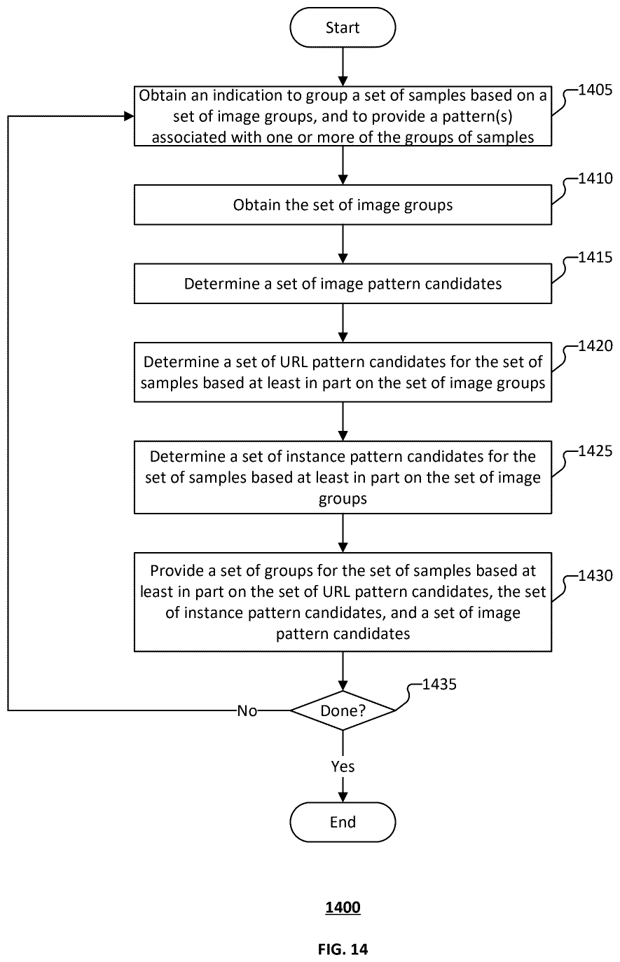

FIG. 14 is a flow diagram of a method for grouping a set of samples according to various embodiments. In some embodiments, process 1400 is implemented at least in part by system 100 of FIG. 1 and/or system 200. Process 1400 may be implemented by an inline security entity, or a cloud security entity or service.

In some implementations, process 1300 may be implemented by one or more servers, such as in connection with providing a service to a network (e.g., a security entity and/or a network endpoint such as a client device). In some implementations, process 1400 may be implemented by a security entity (e.g., a firewall) such as in connection with enforcing a security policy with respect to traffic from/to domains across a network or in/out of the network.

At 1405, the system obtains an indication to group a set of samples based on a set of image groups and to provide a set of patterns associated with one or more of the groups of samples. At 1410, the system obtains the set of image groups. At 1415, the system determines a set of image pattern candidates. The system determines one or more patterns in the images for the samples in a particular image group. At 1420, the system determines a set of URL pattern candidates for the set of samples based at least in part on the set of image groups. The system analyzes the URLs for the samples associated with a particular image group and determines patterns in such URLs. At 1425, the system determines a set of instance pattern candidates for the set of samples based at least in part on the set of image groups. The system analyzes the HTMLs for the samples associated with a particular image group and determines patterns in such HTMLs. At 1430, the system provides a set of groups and their associated set of patterns. The set of groups and associated set of patterns is determined based at least in part on the set of URL pattern candidates, the set of instance pattern candidates, and the set of image pattern candidates. A classifier can classify a sample based at least in part on the set of patterns. For example, the set of patterns can be used to train a classifier, such as a machine learning model, to classify samples based at least in part on the set of patterns. At 1435, a determination is made as to whether process 1400 is complete. In some embodiments, process 1400 is determined to be complete in response to a determination that no further samples are to be allocated to a group, no further groups have associated patterns, no further samples are to be processed, an administrator indicates that process 1400 is to be paused or stopped, etc. In response to a determination that process 1400 is complete, process 1400 ends. In response to a determination that process 1400 is not complete, process 1400 returns to 1405.

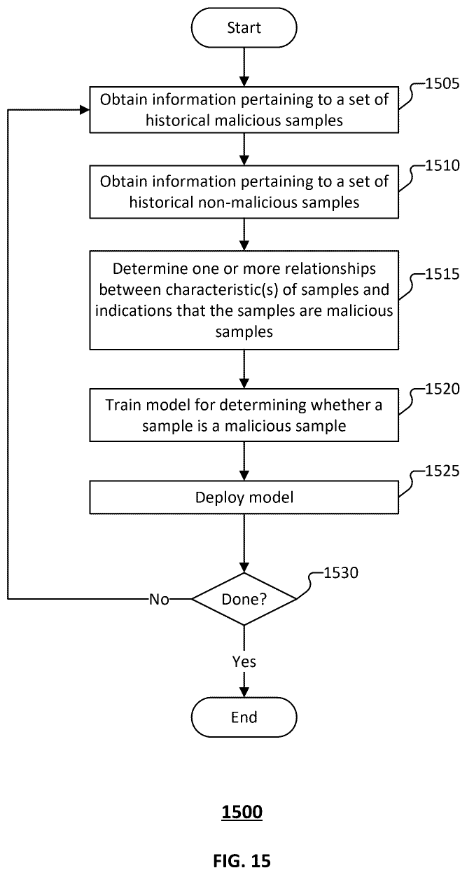

FIG. 15 is a flow diagram of a method for training a model according to various embodiments. In some embodiments, process 1500 is implemented at least in part by system 100 of FIG. 1 and/or system 200 of FIG. 2.

At 1505, information pertaining to a set of historical malicious samples (e.g., network traffic samples) is obtained. In some embodiments, the system obtains the information pertaining to a set of historical known malicious samples (e.g., domains, URLs, web pages, files, etc.) known internally or from a third-party service (e.g., VirusTotal™). At 1510, information pertaining to a set of historical known non-malicious samples (e.g., benign samples) is obtained.

In some embodiments, the system obtains the information pertaining to a set of historical known benign samples from a third-party service (e.g., VirusTotal™). At 1515, one or more relationships between characteristic(s) of samples and indications that the candidate samples are malicious samples. As an example, the system uses the set of patterns associated with a group of samples (e.g., a particular image group) and determines whether a combination of the patterns is indicative of the sample being malicious or benign/non-malicious. The system can determine a set of features to be used by a classifier (e.g., a machine learning model) to classify candidate samples. For example, the system performs feature extraction with respect to the one or more samples for a particular sample group (e.g., an image group). At 1520, a model for determining whether a sample is a malicious sample is trained. The model may be a machine learning model. For example, the model is trained using a machine learning process. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, the model is trained using a long short-term memory networks (LSTM) model. At 1525, the model is deployed. In some embodiments, the deploying of the model includes storing the model in a dataset of models for use in connection with analyzing traffic to determine whether the traffic is to/from a malicious domain. Deploying the model can include providing the model (or a location at which the model can be invoked) to a malicious traffic detector, such as a sample classifier deployed on security platform 140 of system 100 of FIG. 1, or to system 200 of FIG. 2. At 1530, a determination is made as to whether process 1500 is complete. In some embodiments, process 1500 is determined to be complete in response to a determination that no further models are to be determined/trained (e.g., no further classification models are to be created), an administrator indicates that process 1500 is to be paused or stopped, etc. In response to a determination that process 1500 is complete, process 1500 ends. In response to a determination that process 1500 is not complete, process 1500 returns to 1505.

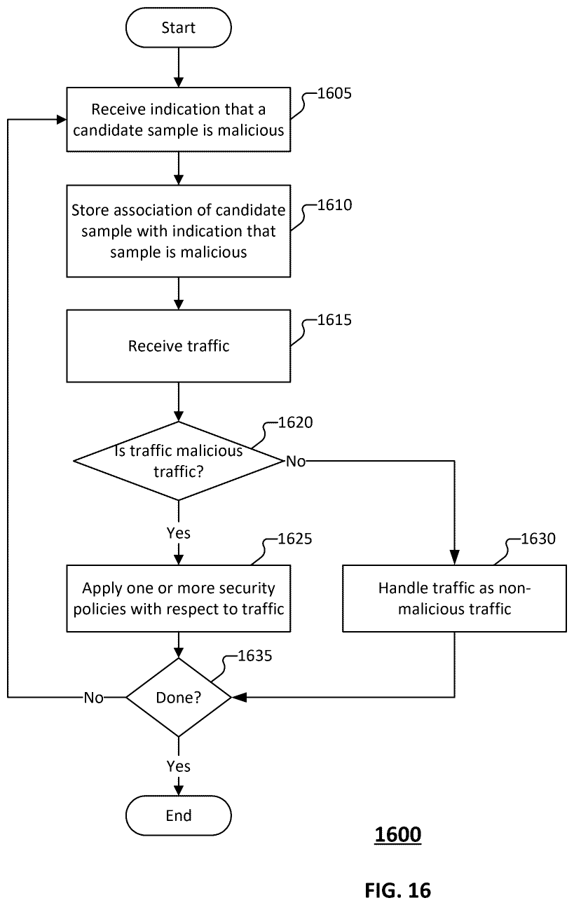

FIG. 16 is a flow diagram of a method for detecting malicious traffic according to various embodiments. In some embodiments, process 1600 is implemented at least in part by system 100 of FIG. 1 and/or system 200. Process 1600 may be implemented by an inline security entity.

In some implementations, process 1600 may be implemented by one or more servers, such as in connection with providing a service to a network (e.g., a security entity and/or a network endpoint such as a client device). In some implementations, process 1600 may be implemented by a security entity (e.g., a firewall) such as in connection with enforcing a security policy with respect to traffic from/to domains across a network or in/out of the network. In some implementations, process 1600 may be implemented by a client device such as a laptop, a smartphone, a personal computer, etc., such as in connection with executing or opening a file such as an email attachment.

At 1605, an indication that a candidate sample is malicious is received. The candidate sample can be obtained from a database, such as a database of samples used to train a classifier. In some embodiments, the system receives an indication that a candidate sample is malicious, and the URL, domain or hash, signature, or other unique identifier associated with the sample. For example, the system may receive the indication that the sample is malicious from a service such as a security or malware service. The system may receive the indication that the sample is malicious from one or more servers.

According to various embodiments, the indication that the sample is malicious is received in connection with an update to a set of previously identified malicious samples (e.g., malicious domains, etc.). For example, the system receives the indication that the sample is malicious as an update to a blacklist of malicious samples (e.g., malicious domains, etc.).

At 1610, an association of the candidate sample with an indication that the sample is malicious is stored. In response to receiving the indication that the sample is malicious, the system stores the indication that the sample is malicious in association with the sample or an identifier corresponding to the sample (e.g., the URL, a hash or signature for the sample, etc.) to facilitate a lookup (e.g., a local lookup) of whether subsequently received traffic is to/from a malicious domain(s). In some embodiments, the identifier corresponding to the sample stored in association with the indication that the sample is malicious comprises a hash of the sample (e.g., a hash of the domain or URL), a signature of the sample, or another unique identifier associated with the sample.

At 1615, traffic is received. The system may obtain traffic such as in connection with routing traffic within/across a network, or mediating traffic into/out of a network such as a firewall, or a monitoring of email traffic or instant message traffic. The traffic may be obtained based on the inline security entity monitoring application traffic or network traffic.

At 1620, a determination of whether the traffic is malicious traffic is performed. For example, the system determines whether intercepted traffic is to/from a malicious domain, etc. In some embodiments, the system obtains a candidate sample from the received traffic. In response to obtaining the candidate sample from the traffic, the system determines whether the candidate sample corresponds to a sample comprised in a set of previously identified malicious samples such as a blacklist of malicious samples (e.g., a blacklist of domains, etc.). In response to determining that the candidate sample is comprised in the set of samples (e.g., domains) on the blacklist of malicious samples, the system determines that the sample is malicious (e.g., that the traffic is to/from a malicious domain).

In some embodiments, the system determines whether the candidate sample corresponds to a sample comprised in a set of previously identified benign samples such as a whitelist of benign samples (e.g., a whitelist of benign domains). In response to determining that the candidate sample is comprised in the set of samples on the whitelist of benign samples, the system determines that the sample is not malicious.

According to various embodiments, in response to determining the candidate sample is not comprised in a set of previously identified malicious sample (e.g., a blacklist of malicious sample, such as domains) or a set of previously identified benign sample (e.g., a whitelist of benign domains), the system deems the sample as being non-malicious (e.g., benign).

According to various embodiments, in response to determining the candidate sample is not comprised in a set of previously identified malicious samples (e.g., a blacklist of malicious domains) or a set of previously identified benign samples (e.g., a whitelist of benign domains), the system queries a malicious sample detector (e.g., a stockpiled domain detector) to determine whether the candidate sample is a malicious sample (e.g., a stockpiled domain, a malicious domains, etc.). For example, the system may quarantine the malicious sample (e.g., the traffic to/from the malicious domain) until the system receives response from the malicious sample detector as to whether the sample is malicious. The malicious sample detector may perform an assessment of whether the candidate sample is malicious such as contemporaneous with the handling of the traffic by the system (e.g., in real-time with the query from the system). The malicious sample detector may correspond to sample classifier deployed by security platform 140 of system 100 of FIG. 1.

In some embodiments, the system determines whether the candidate sample is comprised in the set of previously identified malicious samples (e.g., previously identified malicious domain) or the set of previously identified benign samples (e.g., previously identified benign domains) by computing a hash or determining a signature or other unique identifier associated with the sample (e.g., a hash or signature of the URL, the HTML, etc.) and performing a lookup in the set of previously identified malicious samples or the set of previously identified benign samples for a sample matching the hash, signature or other unique identifier. Various hashing techniques may be implemented.

In response to a determination that the traffic does not correspond to non-malicious traffic at 1620, process 1600 proceeds to 1630 at which traffic is handled as non-malicious traffic/information.

Conversely, in response to a determination that the traffic corresponds to malicious traffic at 1620, process 1600 proceeds to 1625 at which traffic is handled as malicious traffic/information. The system may handle the malicious traffic/information based at least in part on one or more policies such as one or more security policies.

According to various embodiments, the handling of the malicious traffic/information (e.g., traffic to/from a stockpiled domain) may include performing an active measure. The active measure may be performed in accordance with (e.g., based at least in part on) one or more security policies. As an example, the one or more security policies may be preset by a network administrator, a customer (e.g., an organization/company) to a service that provides detection of malicious domains, etc. Examples of active measures that may be performed include: isolating the traffic to/from the malicious domain (e.g., quarantining the traffic), deleting the traffic, prompting the user to alert the user that a malicious domain was detected, providing a prompt to a user when the a device attempts to open access the domain, blocking transmission of information to/from the domain, updating a blacklist of malicious domains (e.g., a mapping of a hash for the domain to an indication that the candidate domain is malicious, etc.

At 1635, a determination is made as to whether process 1600 is complete. In some embodiments, process 1600 is determined to be complete in response to a determination that no further domains are to be analyzed (e.g., no further predictions for domains are needed), an administrator indicates that process 1600 is to be paused or stopped, etc. In response to a determination that process 1600 is complete, process 1600 ends. In response to a determination that process 1600 is not complete, process 1600 returns to 1605.

Although various embodiments described herein pertain to the use of image-based discovery of exploits, the techniques described herein (e.g., the VisCAD techniques for auto-discovery of patterns in images, URLs, and/or HTML) can be implemented to perform classifications along other dimensions.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
group a plurality of images associated with a plurality of samples to obtain a set of image groups, wherein the plurality of images are grouped based at least in part on visual similarities;
determine one or more patterns from URLs for samples associated with images comprised in a particular image group;
generate a signature for each of the determined one or more patterns from the URLs; and
a memory coupled to the one or more processors and configured to provide one or more processors with instructions.

2. The system of claim 1, wherein each image in the plurality of images is an image of website content.

3. The system of claim 1, wherein the plurality of images is grouped based at least in part on performing a hashing of each image.

4. The system of claim 3, wherein the performing the hashing of each image comprises:
obtaining a plurality of hashes based on performing a perceptual image hashing with respect to each image.

5. The system of claim 4, wherein grouping the plurality of images comprises:
determining a first grouping of the plurality of images based at least in part on the plurality of hashes.

6. The system of claim 5, wherein the grouping the plurality of images comprises:
refining the first grouping of the plurality of images to obtain the set of image groups.

7. The system of claim 6, wherein the refining the first grouping of the plurality of image comprises:
encoding the plurality of images based at least in part on a predetermined deep learning model.

8. The system of claim 7, wherein the predetermined deep learning model is ResNet-50.

9. The system of claim 7, wherein the refining the first grouping of the plurality of image further comprises:
determining the set of image groups based at least in part on the encoding of the plurality of images.

10. The system of claim 9, wherein the determining the set of image groups based at least in part on the encoding of the plurality of images comprises:
merging a plurality of groups from the first grouping based at least in part on a similarity among the plurality of groups.

11. The system of claim 1, wherein the one or more patterns from the URLS for samples are determined based at least in part on one or more heuristics.

12. The system of claim 1, wherein the one or more patterns from the URLS for samples are determined based at least in part on performing a deep learning clustering.

13. The system of claim 1, wherein the one or more processors are further configured to:
determine one or more patterns from HTMLs for samples associated with the images comprised in a particular image group.

14. The system of claim 1, wherein the one or more processors are further configured to:
obtain a new sample;
determine a signature for the new sample; and
classify a new sample based at least in part on the signature for the new sample and signatures for the one or more patterns from the URLs.

15. The system of claim 1, wherein the one or more patterns comprises one or more regexes.

16. The system of claim 1, wherein the one or more processors are further configured to:
classify the signature for a particular pattern from the URLs as benign or malicious based at least in part on historical information.

17. The system of claim 1, wherein classification of the signature for a particular pattern is used to train a machine learning model configured to detect malicious samples.

18. The system of claim 1, wherein the signature for a particular pattern is used to cover unclassified URLs to increase detection coverage or reduce false positive maliciousness classifications.

19. The system of claim 1, wherein the plurality of samples are obtained from a database of log data.

20. A method, comprising:
grouping a plurality of images associated with a plurality of samples to obtain a set of image groups, wherein the plurality of images are grouped based at least in part on visual similarities;
determining one or more patterns from URLs for samples associated with images comprised in a particular image group; and
generating a signature for each of the determined one or more patterns form the URLs.

21. A computer program product embodied in a non-transitory computer readable medium and comprising computer instructions for:
grouping a plurality of images associated with a plurality of samples to obtain a set of image groups, wherein the plurality of images are grouped based at least in part on visual similarities;
determining one or more patterns from URLs for samples associated with images comprised in a particular image group; and
generating a signature for each of the determined one or more patterns form the URLs.
